(19) United States
(12) Patent Application Publication
(10) Pub. No.: US 2019/0159501 A1
(43) Pub. Date: May 30, 2019

(54) PROTEIN-FORTIFIED FOOD PRODUCT

(71) Applicant: Coöperatie AVEBE U.A., Veendam (NL)

(72) Inventors: Martine Elisabeth Marie-Louise Assié, Veendam (NL); Mylène Patrice Dominique Caussette, Veendam (NL); Zhenghong Chen, Veendam (NL)

(73) Assignee: Coöperatie AVEBE U.A., Veendam (NL)

(21) Appl. No.: 16/320,898

(22) PCT Filed: Jul. 28, 2017
(86) PCT No.: PCT/NL2017/050507

§ 371 Date: Jan. 25, 2019

(30) Foreign Application Priority Data
Jul. 29, 2016 (EP) 16181999.0

(51) Int. Cl. A23L 33/17; A23J 3/00; A23L 29/30; A23L 29/219; A23L 33/00; A23L 29/262; A23L 29/269

(52) U.S. Cl. CPC A23L 33/17; A23J 3/00; A23L 29/30; A23L 29/269; A23L 33/30; A23L 29/262; A23L 29/219

(57) ABSTRACT

The invention provides a protein-fortified food product, comprising water, a starch thermoreversible gelling agent and at least 2 wt. % of protein. The invention further provides a package, comprising at least one food portion as a single food portion, as well as methods for the serving of food.

### INTRODUCTION

Protein is one of the three macronutrients, along with fat and carbohydrate. It is important that our diet provides sufficient protein, as protein provides amino acids, which are converted in the living body into many types of functional protein.

Many people in present-day society would benefit from increasing their protein intake. Sportsmen for example often benefit from increasing protein intake, because higher protein intake allows for increased muscle build-up.

Furthermore, elderly people often have a reduced stomach content. For these people, the quantity of regular food required to be provided with sufficient protein is often too much. This results in a protein intake which is lower than ideal, with negative consequences for overall health. An additional problem for the elderly is that they often eat relatively slow. Meals which are unstable due to the presence of large quantities of protein are likely to become less attractive when cooled or otherwise loosing the state in which they were served.

Also, there exist a variety of diseases which are associated with increased protein requirements. For patients suffering such diseases, increasing protein intake is much desired, but this can be challenging by a lack of appetite or otherwise not being able to eat enough.

Presently, there exists a variety of high protein foods to solve these issues. For example, protein bars and protein shakes exist which are used to increase protein intake. However, a problem with protein is that it can convey significant off-taste and a gritty mouthfeel, in particular at higher concentrations. This is unpleasant, both in bars and for shakes. Consequently, in particular for foods and food supplements which should provide a large quantity of protein in relatively minor volume, this off-taste and gritty mouthfeel prevent many people from increasing their protein intake.

An additional problem with shakes is that protein is present in suspension. Such a suspension is inherently unstable, and requires stirring or shaking prior to consumption, because the suspended protein is likely to settle relatively quickly.

It would be desirable to have a food product which can provide large quantities of protein in a small volume, without off-taste and gritty mouthfeel, which can be used hot or cold, in the form of a regular meal, and which remains a stable homogenous product from the time of serving to the time of consumption.

WO 2016/01940 describes gels based on any gelling agent, comprising 4-98% of protein or 4-98% of dietary fiber. Such gels are said to increase satiety and reduce total food intake. However, these gels are not necessarily based on a starch gelling agent, and furthermore are not necessarily thermoreversible.

WO 2016/014912 describes high protein gelled food products comprising algal protein and a gel forming material such as gelatin or pectin. These gels are not necessarily thermoreversible, and are not based on a starch gelling agent.

WO 03/015538 describes controlled viscosity food flavoring systems, based on any type of gelling agent, which may among others be starch. In addition, the gels may be thermoreversible, although in many embodiments, heat-reversible gelling is not desired.

WO 2001/1078526 describes reversible gelling agents for use in food products, comprising a degraded root or tuber starch, which starch comprises at least 95 wt. % of amylopectin. It is however silent on the presence of protein.

### FIGURES

FIG. 1: Viscosity of a food product comprising a starch thermoreversible gelling agent during cooling.

FIG. 2: Viscosity of a food product comprising agar during cooling.

FIG. 3: Viscosity of a food product comprising pectin during cooling.

FIG. 4: Viscosity of a food product comprising gelatin during cooling.

FIG. 5: Protein settling in food products with and without gelling agent (25° C., 5 min).

FIG. 6: Degradation of a food product comprising agar under the influence of saliva.

FIG. 7: Degradation of a food product comprising pectin under the influence of saliva.

FIG. 8: Degradation of a food product comprising gelatin under the influence of saliva.

FIG. 9: Degradation of a food product comprising a starch thermoreversible gelling agent under the influence of saliva.

FIG. 10: Results of the sensory evaluation of various food products.

FIGS. 11a-f: A sauce for ready to eat pasta as described in Example 5.

FIGS. 12a-c: Comparison of the gelation behavior of gelled protein-fortified food products based on different thermoreversible gelling agents.

### DETAILED DESCRIPTION

The present invention pertains to a protein-fortified food product, comprising water, a starch thermoreversible gelling agent and at least 2 wt. % of protein. The protein-fortified food product is a nutritional delivery system (NutriDeliS), which is used to provide nutrition with increased quantities of protein. Preferably, the food product is a melted food product, i.e. a liquefied food product, which is a food product in a melted state. The melted food product, after melting of the gel by heating, can also be called a liquefied gel. A melted food product is obtainable for instance by heating the food product in its gelled state, by any known means, such as by oven, in a pan, or by microwave. Microwave is preferred, at least for practical purposes. The present combination of ingredients provides for a palatable taste and mouthfeel of the food product, both in gelled and in melted state. Melting, in the present context, should be interpreted as the liquefaction observed upon heating a thermoreversible gel.

An advantage of the protein-fortified food products is that the starch thermoreversible gelling agent has the function of masking protein taste and mouthfeel by creating a smooth masking layer around the protein. This effect occurs both when the food product is in its gelled state, as well as when the food product is heated so as to obtain the food product in melted, liquid state. This ensures that the gritty mouthfeel and strong off-taste usually associated with high concentrations of protein can be avoided. At the same time, degradation of the smooth layer during consumption provides for a creamy mouthfeel, which improves the apparent taste and mouthfeel of the food product further.

A further advantage is that the composition of the invention retains its liquid state for a considerable time after melting, even when cooled. This ensures that the protein-fortified food product can be melted (“liquefied”) by heating prior to consumption, and retain its liquid state for up to four hours at room temperature (18-25° C., preferably 20° C.). That is an advantage for people who have difficulty eating a large volume of food, as their food tends to cool down during consumption. A food product based on a melted gel according to the invention retains its liquid, consumable state also under these conditions.

At 8 wt. % concentration, it takes about 4 hours for a typical starch thermoreversible gelling agent to gel a liquefied food product, at 0-7° C. In comparison, other hydrocolloid thermoreversible gelling agents gel within minutes, at the same temperature.

The protein-fortified food product comprises a starch thermoreversible gelling agent. This an agent which effects gelling of a liquid or semi-liquid food product, which has been derived from starch, and which provides for a gel which is thermoreversible. In other words, it is a starch-based (or starch-derived) thermoreversible gelling agent.

A gelling agent is an agent which effects gelation of a product which would otherwise be liquid, or at most slightly viscous. This can be achieved by dissolving the gelling agent in the composition at a certain, known concentration, which varies with the type of gelling agent. Gelling agents can also be included at lower concentration, in which case they can provide for binding or thickening a liquid product. Many gelling agents are known, among which pectin, starch, agar, guar gum, protein based gelling agents, alginate, carrageenan, gellan gum, konjac, the combination of locust bean gum and Xanthan gum and gelatin. Most gelling agents form a gel irreversibly; heating of a formed gel in that case disrupts the gel, but cooling the heated gel does not result in a reversal to the gelled state.

A thermoreversible gelling agent is a type of gelling agent which does allow for returning to the gelled state after melting the gel. Thus, multiple cycles of melting and gelling can be achieved, by reciprocal heating and cooling. A thermoreversible gelling agent can be included in a liquid product, for instance at increased temperature, and subsequent cooling results in formation of a gel. Heating this gel results in a melting of the gel, which returns the product to a liquid or melted form. Subsequent cooling reforms the gel.

Generally, when cooling a gel based on a conventional thermoreversible gelling agent, the cooling is concomitantly associated with a return to the gelled state of the product. Known thermoreversible gelling agent are for example gelatin, agar, pectin, starch, gellan gum, and a combination of locust bean gum or guar gum with xanthan gum. Such gelling agents therefore are liquid in a hot state, and gel in a cold state. There is no appreciable intermediate state, in which the product is cold but still liquid.

It has presently been found that a starch thermoreversible gelling agent has the property of retaining its melted form for a long time after cooling, much longer than other thermoreversible gelling agents. Starch-based thermoreversible gelling agents are characterized by a low gel set rate, of at least 2, preferably at least 4 hours at 4° C. and 8 wt. % concentration. However, both in a melted state and in a gelled state, the polysaccharide chains of the starch thermoreversible gelling agent exert a masking effect on protein taste and mouthfeel. In addition, both in melted and in gelled state, the food products of the invention prevent settling of the protein.

The starch may be of any type, such as a legume, cereal, root or tuber starch, but is preferably a root or tuber starch. Starch types which may be used to obtain the starch thermoreversible gelling agent are for example rice, wheat, maize, potato, sweet potato, tapioca or yam starch, preferably a root- or tuber starch, preferably potato and tapioca starch, most preferably potato starch. An advantage of using root or tuber starches. In particular potato starch, over other types of starch is that root- or tuber starches can be obtained in a more pure form than other starches. In addition, they have higher clarity, and have lower color, odor and off taste.

Among the various starch types, any ratio of amylose to amylopectin can be used. Regular starch comprises generally about 20 wt. % amylose, and 80 wt. % amylopectin. Amylose-rich starch has a higher amylose content, and so-called “waxy” starches have an increased amylopectin content, preferably of above 95 wt. %, more preferably above 98 wt. %, based on the weight of the starch. In the present invention, the starch thermoreversible gelling agent is preferably a waxy starch, such as waxy maize or wheat starch, or amylopectin potato starch. In a much preferred embodiment, the starch is an amylopectin potato starch.

The starch thermoreversible gelling agent may be a modified starch, including modification by degradation, among which degradation by acid, by oxidation or by enzymatic or mechanical methods or the combination method. Degradation by oxidation, for example peroxide or hypochlorite oxidation, or by acid is preferred, most preferably by acid. Suitable acids are known in the art, and include HCl, H₂SO₄ and HNO₃, for example. HCl is preferred for food purposes.

A much preferred starch thermoreversible gelling agent is for example an acid-degraded waxy starch, preferably an acid-degraded amylopectin potato starch.

The starch thermoreversible gelling agent may also (additionally) be modified by slight stabilization, such as by etherification, esterification or amidation of the starch. As such, the starch thermoreversible gelling agent can also be a stabilized starch. Suitable stabilized starches are for example acetylated or hydroxypropylated starches.

Combinations of modifications are also envisioned. It is however important that the modification(s) do not affect the thermoreversibility of the thermoreversible gelling agent. In addition, the modification(s) should not preclude the degradation of the starch during consumption, as this is an important aspect of the improved mouthfeel of the food products of the invention.

A starch thermoreversible gelling agent generally has a peak viscosity, determined by RVA (Rapid Visco Analyser, Newport Scientific Pty Ltd). 45% starch (db) in demineralized water. The viscosity can be measured by increasing the temperature from 35° C. to 95° C. at 12° C./min with a paddle speed is 160 rpm. Then keep at 95° C. for 3 min and then decrease to 35° C. at 12° C./min in the range of 100 cp to 13000 cp.

A starch thermoreversible gelling agent generally has a molecular weight, determined by a F4 method (Field flow fractionation) at a sample concentration of 1.180 mg/ml and injection volume of 50.0 μl. The average molecular weight is in the range of 0.01×10⁶to 50×10⁶ g/mol.

In a much preferred embodiment, the starch thermoreversible gelling agent is an acid-degraded amylopectin potato starch, preferably with a molecular weight of between 0.05×10⁶ to 0.5×10⁶ g/mol, and/or a viscosity of 200 to 1000 cp determined by RVA (Rapid Visco Analyser, Newport Scientific Pty Ltd). 45% starch (db) in demineralized water. The viscosity was measured by increasing the temperature from 35° C. to 95° C. at 12° C./min with a paddle speed is 160 rpm. Then keep at 95° C. for 3 min and then decrease to 35° C. at 12° C./min.

A starch thermoreversible gelling agent can be obtained by suitable modification of starch, as is known in the art. A much preferred starch thermoreversible gelling agent is a starch as disclosed in WO 2001/1078526, which can be obtained as described therein.

The starch thermoreversible gelling agent is present in the food product of the invention in a quantity sufficient to mask the protein. Preferably, the quantity is such that it allows for the food product to obtain a gelled state. Dependent on the type of food product, this can already occur at a quantity of starch thermoreversible gelling agent in the food product of 3 wt. % or more, based on the total weight of the food product. Generally though, higher quantities are desirable, such as a quantity of more than 5 wt. %, preferably more than 8 wt. %, based on the total weight of the food product. The starch thermoreversible gelling agent can be present up to a quantity of 35 wt. %, preferably up to 40 wt. %, more preferably up to 45 wt. %. It is a further advantage of the invention that a starch thermoreversible gelling agent forms a relatively soft gel up to rather high concentrations. This means that gels with a relatively high solids content can be obtained, which provide for high carbohydrate energy presence, and at the same time may increase the frequency of bowel movement.

The protein-fortified food product further comprises at least 2 wt. % of protein, based on the total weight of the composition. It is an advantage of the present invention that the presence of the starch thermoreversible gelling agent masks the taste and mouthfeel of the protein, by including the protein in a network of polysaccharide chains. Without wishing to be bound by theory, it appears that the starch thermoreversible gelling agent forms a thin hydrodynamic shell around the protein. In a gelled state, this means that the protein is taken up in the gel network, masking both taste and mouthfeel.

Surprisingly, this also functions in a liquid state of the gel. After melting the gel by heating, protein apparently remains associated with the polysaccharides which formed the gel network, even when the gel network itself has been disturbed by the melting. Thus, protein taste and mouthfeel is also masked in the melted food product.

The food product of the invention can be in a gelled state. Consequently, in preferred embodiments, the invention pertains to a food product which is a solid gel, defined as a gel which without support or mold does not change shape under the force of gravity for at least one day. At room temperature, this equates to gels with a viscosity of more than 10⁵ cP.

In other preferred embodiments, the food product is a melted food product, having a viscosity of 100-45000, preferably 100-35000 cP, more preferably 500-30000 cP, or even more preferably 100-25000 cP. The viscosity of the melted food product is determined after melting, by a Rapid Visco Analyser (RVA) at 37° C. at a paddle speed of 19 rpm. The skilled person knows how to adjust the concentration of the starch thermoreversible gelling agent in order to obtain a gel, or a melted gel, of a certain viscosity.

At higher protein concentrations, the negative effects associated with protein-rich foods become more apparent. It is a further advantage of the present invention that protein off-taste and gritty mouthfeel is even masked when protein is present in significant quantities. Thus, in particularly preferred embodiments, the protein content of a food product according to the invention is at least 2 wt. % of protein, more preferably at least 8 wt. % of protein, more preferably at least 12 wt. %, even more preferably at least 15 wt. %, of protein, based on the total weight of the food product. Protein content in the present food products may even be as high as 45 wt. %. Alternatively, it may be as high as 35 wt. %, based on the total weight of the food product.

The protein in the present food product may have any form. It may be native protein, but it may also be a fully or partially denatured or hydrolyzed protein. Preferably, the protein is a fully or partially denatured protein, as such protein is cheapest to obtain. An alternative preferred type of protein is a fully or partially hydrolyzed protein. Such protein is easy to digest and take up. In a much preferred alternative embodiment, hydrolyzed protein is a partially hydrolyzed protein. The protein may furthermore be any mixture of the above forms.

The protein may be of any food-grade type, such as pea protein, soy protein, milk protein, whey protein, rice, wheat, algae protein, casein, meat protein, fish protein, oat protein, canola protein or potato protein. Preferred protein types are soy protein, milk protein, casein, whey protein, pea protein and potato protein, most preferably potato protein. The skilled person can readily adjust the protein type based on the constituent amino acid profile, and adapt protein type to match specific amino acid requirements.

For example, in order to provide a food product which can provide improved muscle buildup, protein rich in branched amino acids can be used, for example whey protein, casein, or potato protein.

All types of protein are commercially available from many sources.

The food product of the invention may additionally comprise other ingredients, increasing the nutritional value and/or the taste of the product. Thus, the food product may further comprise one or more food-grade components selected from the group of fat, oil, carbohydrate, fiber, mineral, salt, sugar, acid, micronutrient, vitamin, antioxidant, flavonoid, colorant, flavoring compound, thickeners, and preservatives.

Suitable fats include for example butter, lard, duck fat, and coconut fat.

Suitable oils include for example plant oils such as sunflower oil, olive oil, safflower oil, almond oil, walnut oil, palm oil, soybean oil, canola oil, coconut oil, rapeseed oil, peanut oil, as well as microbial oils and fish oils. Microbial and fish oils with a high polyunsaturated fatty acid content are preferred. Alternative preferred oils are olive oil, sunflower oil and palm oil.

Suitable carbohydrates include for example polysaccharides, such as starch, among which modified and/or stabilized starches as defined above, with the exception of starch thermoreversible gelling agents, as well as oligosaccharides such as maltodextrins, raffinose, stachyose and fructo-oligosaccharides.

Suitable fibers include for example soluble as well as insoluble dietary fibers such as b-glucans, inulin, pectin, lignin and alginic acids, as well as hemicellulose, chitin, xanthan gum, resistant starches, fructans and maltodextrins.

Suitable minerals include for example calcium, phosphorus, potassium, sodium, and magnesium.

Suitable salts include for example sodium chloride, potassium chloride or potassium iodide.

Suitable sugars include monosaccharides and disaccharides, for example glucose, fructose, galactose, sucrose, glucose syrup, maltose, lactose. In some embodiments, a food-product of the invention is lactose-free.

Suitable acids include for example acetic acid, citric acid, tartaric acid, malic acid, fumaric acid, and lactic acid.

Suitable micronutrients include for example iron, cobalt, chromium, copper, iodine, manganese, selenium, zinc, boron, and molybdenum, as well as iodine, fluoride, and phosphorous.

Suitable vitamins include for example vitamins A, C, E, K, B₂, B₃, B₅, B₆, B₇, B₈, B₉, B₁₁ and B₁₂

Suitable antioxidants include for example polyphenols, anthocyanins, ascorbic acid, tocopherol, carotenoids, propyl gallate, tert-butylhydroquinone, butylated hydroxyanisole, and butylated hydroxytoluene.

Suitable flavonoids include for example rutin and kaempferol.

Suitable colorants include for example artificial and natural food colors, among which artificial colors quinoline yellow, carmoisine, ponceau 4R, patent blue V, Green 5, or alternatively Brilliant Blue FCF, indigotine, fast green FCF, Erythrosine, Allura Red AC, tartrazine, sunset yellow FCF. Natural colors include carotenoids, chlorophyllin, anthocyanins, and betanin.

Suitable flavoring compounds include artificial and natural sweeteners, such as asparatame, cyclamate, saccharin, stevia, sucralose, acesulfame K, and mogrosides, as well as for example vanillin or glutamic acid salts.

Suitable thickeners include for example guar gum, agar, various starch-based non-thermoreversible gelling agents, pectin, gelatin, alginic acid and carrageenan.

Suitable preservatives include for example benzoic acid or salts thereof, hydroxybenzoate, lactic acid, nitrate, nitrite, propionic acid and salts thereof sulfur dioxide and sorbic acid.

Alternatively or additionally, the food product may comprise one or more of the additional ingredients fruit, vegetable, meat, fish, dairy products.

Suitable fruits include for example apple, pear, berries, pineapple, mango, coconut, peach or banana.

Suitable vegetables include for example carrots, onions, garlic, cabbage, beans, lentils, broccoli and tomato.

Suitable meats include for example pig, cow, chicken, turkey or horse meat.

Suitable fish include for example cod, sea bass, pollock, salmon, trout and tilapia, as well as shellfish, shrimp and squid.

Suitable dairy products include for example milk, cream, yoghurt, cheese or sour cream.

In preferred embodiments, additional ingredients are present chopped or finely cut, or even mashed or blended, in the food product.

Alternatively or additionally, the food product may comprise one or more pharmaceutical compounds, for example antihypertensive medications, analgesics or proton pump inhibitors.

It is a distinct advantage of the invention that the present food products can be in gelled form, which subsequently can be melted by heating the food product. After melting, the food products retain their liquid state for at least 4 hrs, so that the present invention provides a food product with the advantageous effects of a gel in protein masking, while allowing consumption in a liquid state. Thus, the invention preferably pertains to liquid or semi-liquid food products, wherein liquid or semi-liquid is defined as having a viscosity of 100-45000, preferably 100-35000 cP, more preferably 500-30000 cP, or even more preferably 100-25000 cP. The viscosity of the melted food product is determined after melting, by a Rapid Visco Analyser (RVA) at 37° C. at a paddle speed of 19 rpm.

Thus, the invention may pertain to a sauce, such as for example a pasta-sauce, which is enriched in protein by supplementation by addition of protein as defined above, but which furthermore comprises the regular ingredients of a pasta sauce.

The food product may be prepared by adding the starch thermoreversible gelling agent to the food product, and by adding the additional protein, simultaneously or sequentially in any order. Subsequently, the food product may be cooled and rested to obtain the gelled food product. The gelled food product may be consumed as such, but preferably, the gelled state of the food product is used to dispatch the food product to the location where it is to be consumed. Simple heating, such as by microwave, of the gelled food product at the location of consumption then transforms the food product to the melted food product, which may be consumed even very slowly, after cooling to room temperature, without returning to the gelled state.

In some embodiments, the food product of the invention can be provided in blocks, which may be cut into servable portions prior to heating, or which may be heated as such to provide many portions of the melted food product. In preferred embodiments however, the food product of the invention is provided as a single food portion. The single food portion preferably has a three-dimensional shape, preferably selected from a block, slice, disk, shred, ball or oval. Providing the food product of the invention as single food portions has the advantage that the composition of the food product can be tailored to individual needs or taste, on the basis of individual protein requirements, individual requirements for pharmaceutical compounds, and individual diet wishes such as vegetarian, vegan, kosher or halal food products.

Thus, the invention furthermore pertains to a package, comprising at least one food product in the form of a single food portion. Preferably, the package comprises multiple single food portions, for example multiple portions tailored to the need of different individuals, or multiple food portions tailed to the need of a single individual, while allowing for a varied diet at least in taste and composition of the food product. An advantage of these food portions is that they can be distributed in a gelled state, which makes distribution easier as there is no dripping or spilling when the food product is transferred to a plate, and which allows for well-defined food portions without measuring quantities.

These embodiments further have the advantage of providing food portions for individuals, which may be produced on large scale in one location, while being tailored to individual needs, for consumption at a specific location. Preferred locations for consumption of the present food products are elderly homes, hospitals, and other locations where varying diet needs and wishes can be coupled to individual inhabitants, but where the large scale requirements for food distribution complicates meeting individual needs and wishes. The present invention provides for individualized food portions, which may be efficiently produced and distributed.

The invention furthermore provides a method for serving protein-fortified food, comprising

1) providing a food product as defined above

2) heating the food product to obtain a melted food product, having a viscosity of 100-45000 cP, preferably 35000 cP.

3) serving the food.

In preferred embodiments, the food product can be combined with other food products, such as for example a servable portion of a meal or meal base selected from the group of pasta, noodles, rice, bread, potato, dessert or ice cream.

These embodiments allow for meeting individual food requirements based on the food product of the invention, for instance a pasta-sauce, which may be applied onto pasta prepared at the location of serving. Alternatively, the food product can be a chili, served with rice or bread prepared at the location of serving, or obtained elsewhere. The food product can also be a spread, to be applied on bread. Heating of the spread in its gelled state provides the melted spread with regular spread-viscosity, which can be cooled and applied onto bread and subsequently served, without the food product returning to its gelled state.

In much preferred embodiments, the food product can be a sauce for application on for example ice-cream or another type of dessert. In such embodiments, the advantage of the food product, that it retains its liquid state for a long time is in particular apparent, as even on ice-cream, the melted and subsequently cooled gel does not return to its gelled state within four hours. This time is sufficient to consume the food product, even for the slowest eaters.

Consequently, the invention further provides a method for protein fortification in healthy subjects, comprising serving a protein-fortified food as defined above, in a gelled or melted form. Preferably, serving is in melted form. Preferred healthy subjects include for example sportsmen and elderly.

The invention furthermore provides a food product for use in protein fortification, in subjects suffering from protein deprivation or otherwise in need of high quantities of protein, as well as a method for supplementing protein to patients suffering from protein deprivation or otherwise in need of high quantities of protein. Subjects envisioned for this use of the invention include diseased and/or underfed subjects.

The invention furthermore provides a method of making a gelled food product as defined above, comprising mixing water, a starch thermoreversible gelling agent and at least 2 wt. % protein, heating the mixture to fully gelatinize the starch, and cooling the mixture for at least 5 hours, preferably at least 10 hours, to obtain the gelled food product. In preferred embodiments, the gelled food product can subsequently be melted by heating to obtain a food product in melted state. Heating is preferably to a temperature of at least 70° C., preferably at least 80° C., more preferably at least 90° C. Preferably, the food product is poured into a package to provide a single food portion prior to cooling.

For the purpose of clarity and a concise description features are described herein as part of the same or separate embodiments, however, it will be appreciated that the scope of the invention may include embodiments having combinations of all or some of the features described.

The invention will now be further illustrated by the following, non-restrictive examples.

### EXAMPLES

In examples 1-4, the melted food product is prepared by mixing the ingredients together and gelatinizing the starch completely. This mixture could be cooled overnight at for instance room temperature or even cooler to result in the food product in a gelled state. Heating of this gelled food product then would result in the melted food product. A thus obtained melted food product is chemically exactly the same as the mixture obtained directly after combining the ingredients and gelatinizing the starch, because the starch is a starch thermoreversible gelling agent, gelation of which does not impose other changes to the food product than its texture. Therefore, the mixture obtained after combining the ingredients and gelatinizing the starch is used to show the advantages of the invention, without the intermediate steps of cooling, gelling and melting, for efficiency reasons. In examples 5 and 6, the intermediate steps are also shown.

### Example 1

### Effect of Temperature on Viscosities of the Sauces with Different Gelling Agents

### Materials:

1. Gelling agent:
   Eliane Gel 100: acid degraded amylopectin potato starch produced by AVEBE, the Netherlands;
   Gelatin: food grade gelatin (200 bloom) produced by Suntran Chemical Co, Ltd, China;
   Agar-agar: food grade agar-agar produced by Suntran Chemical Co. Ltd, China;
   Pectin: Citrus pectin powder (LM) produced by Foodchem International Corporation, China;
2. Protein:
   Pea protein isolate: produced by Cosucra, Belgium;
3. Sugar: Sugar (sucrose) produced by Suiker Unie, the Netherlands;
4. Salt: Salt produced by Akzo Nobel Functional Chemicals B.V. Netherlands:

### Methods:

The samples were prepared by the following recipes:

TABLE 1
Sample recipes for viscosity measurement during temperature
change

| | % | % | % | % |
|---|---|---|---|---|
| Ingredient | (Eliane Gel 100) | (Agar-agar) | (Pectin) | (Gelatin) |
| Protein (soya) | 10 | 10 | 10 | 10 |
| Eliane Gel 100 | 8 | / | / | / |
| Agar-Agar | / | 0.8 | / | / |
| Pectin | / | / | 0.8 | / |
| Gelatin | / | / | / | 3.5 |
| Sugar | 5 | 5 | 5 | 5 |
| Salt | 1 | 1 | 1 | 1 |
| Water | 61 | 68.2 | 68.2 | 65.5 |

### Test Method:

Eliane Gel 100, agar-agar, pectin and gelatin were added into a beaker with tap water respectively. Then the samples were cooked in a water bath at 100° C. until Eliane gel 100 completely gelatinized and agar-agar, pectin and gelatin completely dissolved. The protein was mixed in dry form with sugar and salt and then added into the above solutions under gentle stirring. The mixtures were then cooked in a water bath at 90° C. for 5 minutes.

25 g of each sample was transferred into a RVA (Rapid Visco Analyser, Newport Scientific Pty Ltd) cup and then measured by using a RVA. The samples were measured at 50° C. and held for 5 min at this temperature, before the solution was cooled to 10° C. at a rate of 4° C./min with a paddle speed of 19 rpm. The viscosities of the sample were recorded.

### Results and Conclusion:

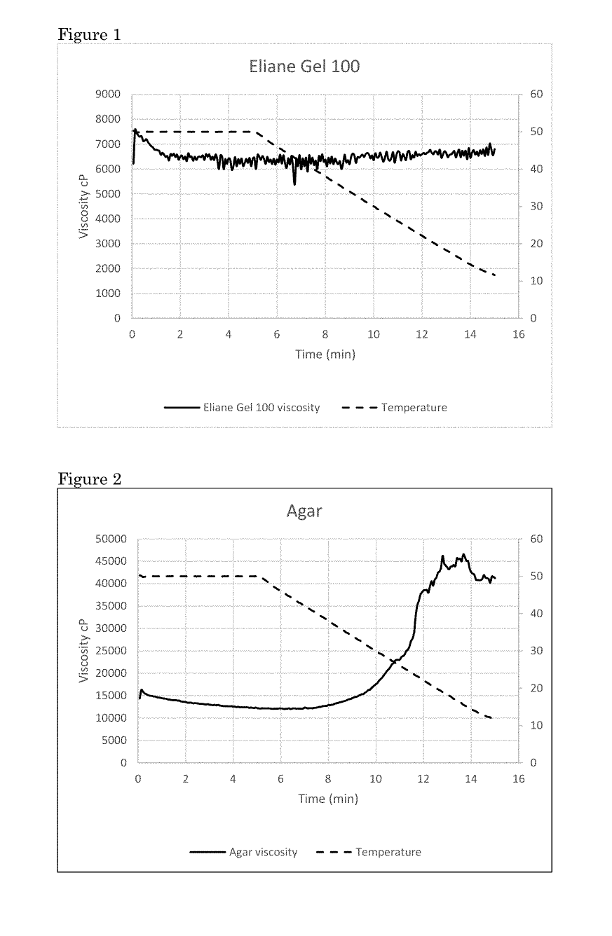

It can be seen in FIG. 1 that the viscosity of the sample prepared with a starch thermoreversible gelling agent was very stable when the temperature decreased from 50° C. to 10° C. This indicates that the gel after melting retains its melted state for a long time, even when cooling to 10° C. This property of starch thermoreversible gelling agents assures that a food product can be easily consumed at room temperature and even at lower temperature, while retaining the appearance and mouthfeel of a cooled liquid product, and while at the same time masking protein taste.

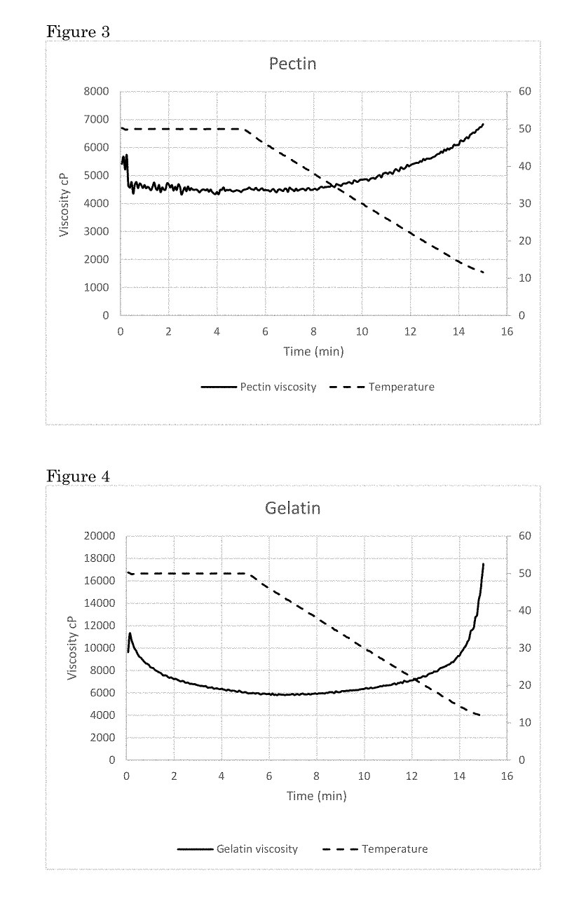

FIGS. 2, 3 and 4 show the viscosities of the samples prepared agar-agar, pectin and gelatin, respectively. The viscosity increased within minutes of decreasing the temperature. FIG. 2 shows the sample prepared with agar-agar became thicker (viscosity increased) within a few minutes when the temperature decreased to 35° C. The viscosity increased dramatically and immediately after the temperature was lower than 30° C. Like agar-agar, the viscosity of the sample prepared with gelatin (see FIG. 4) started to increase when cooled to 30° C. and then further increased significantly after the temperature was lower than 15° C. The process of reverting to the gelled state took place within a few minutes after reaching temperatures which were even higher than normal room temperature (18-25° C., preferably 20° C.). The sample prepared with pectin (FIG. 3) started to increase viscosity from 35° C. and then increased steadily with the decreasing of temperature. Also with pectin, the sample had reverted to the gelled state within minutes of reaching room temperature. This indicates that the samples prepared with the gelling agents of agar-agar, pectin and gelatin return to the gelled state within a timespan of at most a few minutes after cooling to room temperature, which means that food products based on such gels would have to be consumed in the gelled state, rather than the liquid state, after cooling to room temperature or lower.

### Example 2

### Comparison of Protein Settling of a Food Product With and Without a Starch Thermoreversible Gelling Agent

### Materials:

1. Gelling agent:
Eliane Gel 100: acid degraded waxy potato starch produced by AVEBE, the Netherlands;
2. Protein:
Potato protein (Solanic 100) produced by AVEBE, the Netherlands;
3. Sugar: Sugar (sucrose) produced by Suiker Unie, the Netherlands;
4. Salt: Salt produced by Akzo Nobel Functional Chemicals B.V. Netherlands;

### Method:

The samples were prepared according to the following recipe:

TABLE 2
Sample recipe for separation measurement

| | starch | |
|---|---|---|
| | thermoreversible | |
| | gelling agent | comparison |
| Ingredient | [wt. %] | [wt. %] |
| Protein | 10 | 10 |
| Eliane Gel 100 | 8 | / |
| Sugar | 5 | 5 |
| Salt | 1 | 1 |
| Water | 76 | 84 |

Eliane Gel 100 was added into a beaker with tap water and then cooked in a water bath at 100° C. under gentle stirring until Eliane gel 100 completely gelatinized. The protein, sugar and salt were added into the beakers respectively according to the recipe (table 2), and then cooked at 90° C. for 5 min. The mixture was cooled to 25° C. and transferred into a 100 ml graduated cylinder (FIG. 5). The mixture was kept at 25° C. for 5 min and then the supernatant was collected with a pipet. The supernatant was weighed, and the protein settling was calculated according to the following formula.

Separation %=100*supernatant (g)/total sample (g)

### Result and Conclusion:

TABLE 3
Settling of the samples prepared with and without Eliane Gel 100

| Sample | Eliane Gel 100 | Blank |
|---|---|---|
| protein settling (%) | 5.6 | 21.8 |

Table 3 shows that protein settling in the food product decreased significantly when a starch thermoreversible gelling agent was applied. This suggests that a starch thermoreversible gelling agent can make the structure of the protein-fortified food product homogeneous during consumption.

### Example 3

### Degradation of the Starch Thermoreversible Gelling Agent During Consumption

### Materials:

1. Gelling agent:
   Eliane Gel 100: acid degraded waxy potato starch produced by AVEBE, the Netherlands;
   Gelatin: food grade gelatin (200 bloom) produced by Suntran Chemical Co. Ltd, China;
   Agar-agar: food grade agar-agar produced by Suntran Chemical Co. Ltd, China;
   Pectin; Citrus pectin powder (LM) produced by Foodchem International Corporation, China;
2. α-amylase: α-amylase (BAN 480) was obtained from Novozymes.

### Method:

Solutions comprising 45 wt. % Eliane Gel 100, 5 wt. % agar-agar, 12 wt. % pectin and 22 wt. % gelatin were prepared with tap water. Eliane Gel 100 was gelatinized by cooking in a water bath at 100° C. for 5 min. Agar-agar, pectin and gelatin were completely dissolved in water by heating in a water bath at 90° C. under gentle stirring. This provided four sample solutions with highly similar viscosity.

All the samples were then kept in a water bath at 37° C. for further measurement. 25 g of the sample was transferred into a RVA cup and the viscosity was measured by using a RVA at 37° C. with a paddle speed of 19 rpm for 10 min. After the measurement, 15 μg of α-amylase as a saliva model was added and the measurement was repeated. The viscosities of the samples with and without α-amylase were recorded.

### Results and Discussion:

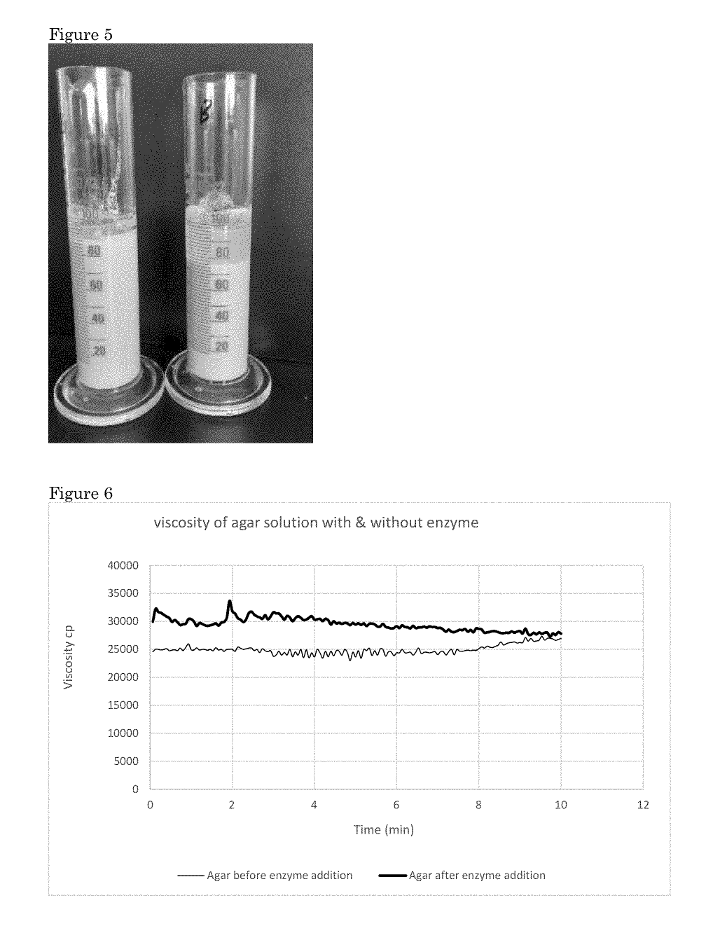

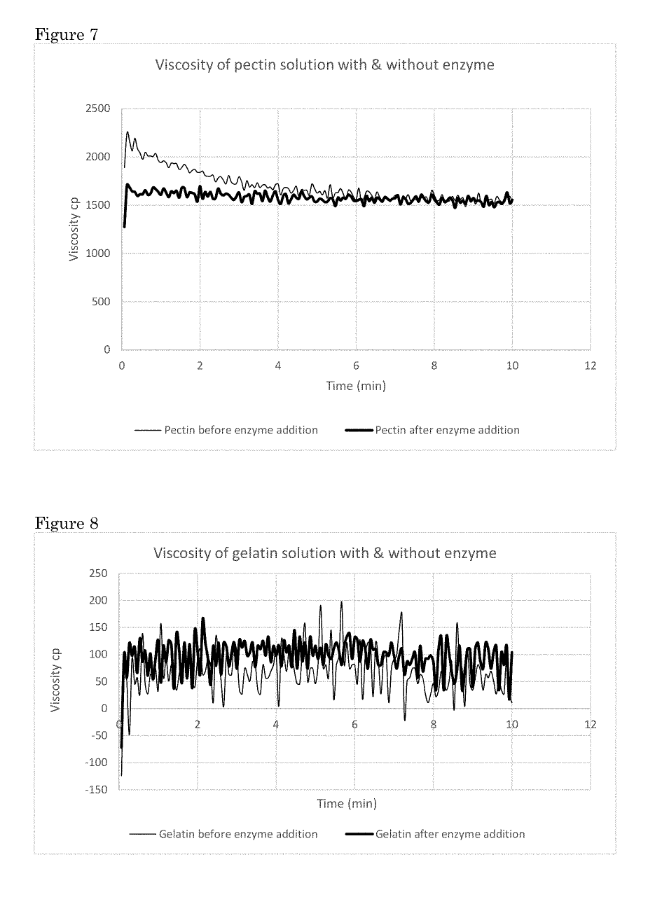

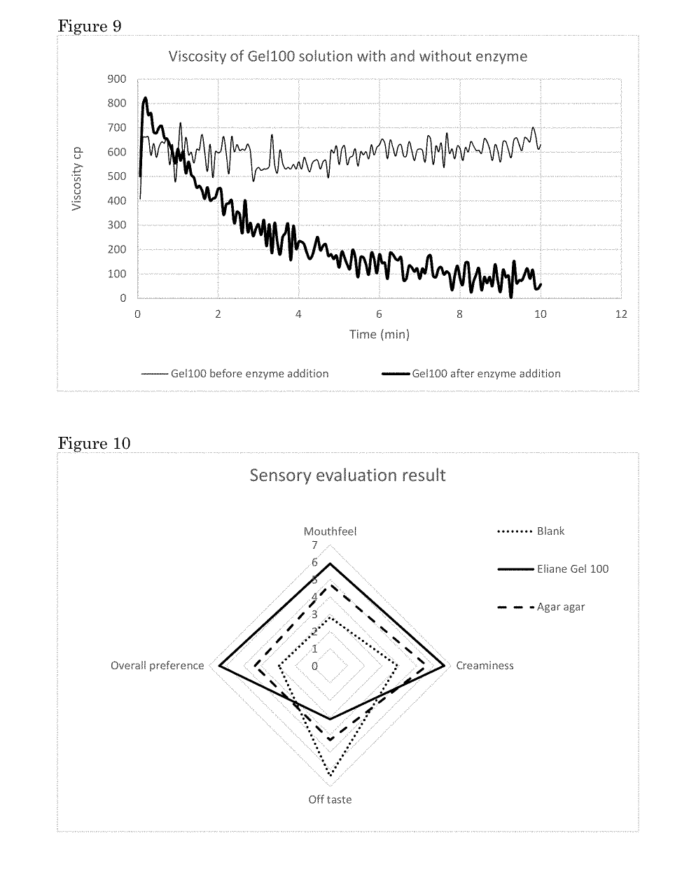

The viscosities of all the other thermoreversible gelling agents (agar-agar, pectin and gelatin) did not show any changes during measurement before and also after adding α-amylase (see FIGS. 6, 7 and 8). Only Eliane Gel 100 (FIG. 9) showed significant degradation of the gelling agent upon addition of amylase, which can be seen by the decrease in viscosity. This shows that a starch thermoreversible gelling agent can be quickly degraded during consumption under the influence of saliva. The degradation of the food product under the influence of saliva provides a creamy sensation, leading to a creamy mouth-feel.

### Example 4

### Sensory Evaluation of Food Products Prepared with Different Thermoreversible Gelling Agents

### Materials:

1. Gelling agent:
   Eliane Gel 100: acid degraded waxy potato starch produced by AVEBE, the Netherlands;
   Gelatin: food grade gelatin (200 bloom) produced by Suntran Chemical Co. Ltd, China;
   Agar-agar: food grade agar-agar produced by Suntran Chemical Co. Ltd, China;
   Pectin: Citrus pectin powder (LM) produced by Foodchem International Corporation, China;
2. Protein: Pea protein isolate: produced by Cosucra, Gelgium;
3. Sugar: Sugar (sucrose) produced by Suiker Unie, the Netherlands;
4. Salt: Salt produced by Akzo Nobel Functional Chemicals B.V. Netherlands;
5. Tomato puree: Tomato puree (Grand Gerard) produced by Sligro B.V., the Netherlands;
6. Dairy cream: Verse Slagroom (40% fat) produced by Campina, the Netherlands;

### Method:

The food products were prepared by the following recipe (see table 4). All gelling agent (Inane Gel 100 and agar-agar) solutions were prepared with tap water by using the previous method, followed by adding dairy cream. The protein powder, sugar and salt were premixed and then added into the above solution respectively. Then the tomato puree were added into the mixtures respectively. The sauces were cooked in a water bath at 100° C. for 5 min, and subsequently cooled to 30° C. and transferred into a 20 ml sensory cup for sensory panel test.

The sensory panel consisted of 10 well trained people. The sensory indicators of the food product were evaluated by the following attributes and scored by the intensity (see table 5). The attribute definitions were marked by each panelist on a score from 1 to 10, where 1 represents the lowest intensity, and 10 represents the highest intensity. The attributes marked were Mouthfeel (smoothness), creaminess, off-taste and overall preference.

TABLE 4
Recipe of the protein sauce used for sensory evaluation

| | Eliane Gel 100 | Agar-agar | Blank 20 |
|---|---|---|---|
| Ingredient | (%) | (%) | (%) |
| Protein | 15 | 15 | 15 |
| Eliane Gel 100 | 8 | / | / |
| Agar-Agar | / | 0.8 | / |
| Sugar | 5 | 5 | 5 |
| Salt | 1 | 1 | 1 |
| Tomato puree | 10 | 10 | 10 |
| Dairy cream | 6 | 6 | 6 |
| Water | 55 | 62.2 | 63 |

Result and Conclusion:

The sensory evaluation forms were collected and the average value of each attribute of different samples were used for the comparison. This led to the results displayed in table 5.

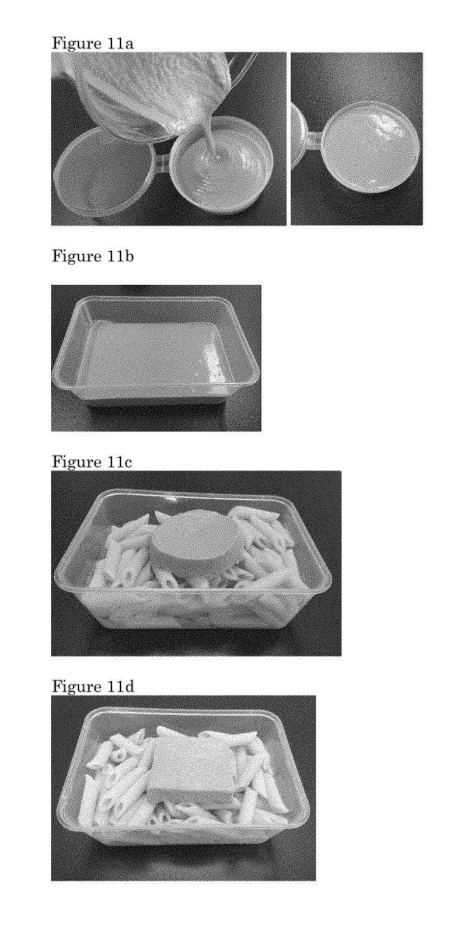

It can be seen that the protein sauces prepared with gelling agents (Eliane Gel 100 and Agar-agar) have better mouthfeel and higher creaminess but less off taste. Over all, the sauces prepared with gelling agents were more preferred by the panelist. Compare with agar-agar, the sauce prepared with Eliane Gel 100 showed creamier and better mouthfeel which is in agreement with the result of α-amylase degradation result. The sauce prepared with Eliane Gel 100 was more preferred by the panelist and the off taste is lower than that prepared with agar-agar. This result indicates that Eliane Gel 100 can significantly mask the off taste of the protein, and can improve the mouthfeel, creaminess and overall preference for the protein-fortified food products (see FIG. 10).

TABLE 5
Results of the sensory evaluation

| | | | | Overall |
|---|---|---|---|---|
| Sample | Mouthfeel | Creaminess | Off taste | preference |
| Blank | 2.8 | 3.9 | 6.4 | 2.95 |
| Starch | 5.9 | 6.6 | 3.1 | 6.4 |
| thermoreversible | | | | |
| gelling agent | | | | |
| Agar-agar | 4.7 | 5.6 | 4.3 | 4.35 |

### Example 5

### Preparation of Making and the Use of the Thermos-Reversible High Protein Gelled Sauce for Ready to Eat Pasta

### Materials:

1. Gelling agent:
   Eliane Gel 100: acid degraded waxy potato starch produced by AVEBE, the Netherlands;
2. Protein;
   Potato protein (Solanic 100) produced by AVEBE, the Netherlands;
3. Sugar: Sugar (sucrose) produced by Suiker Unie, the Netherlands;
4. Salt: Salt produced by Akzo Nobel Functional Chemicals B.V. Netherlands;
5. Tomato puree: Tomato puree (Grand Gerard) produced by Sligro B.V., the Netherlands;
6. Dairy cream: Verse Slagroom (40% fat) produced by Campina, the Netherlands;

### Method:

The thereto-reversible high protein gelled sauce was prepared according the following recipe (see table 6).

TABLE 6
Recipe of the thermoreversible high protein gelled sauce

| Ingredient | (%) |
|---|---|
| Solanic 100 (Potato protein) | 15 |
| Eliane Gel 100 | 8 |
| Tomato puree | 10 |
| Sugar | 5 |
| Salt | 0.8 |
| Dairy cream | 10 |
| Water | 51.2 |

### Preparation:

Eliane Gel 100 was dispersed in water and cooked au bain marie at 100° C. until Eliane gel 100 completely gelatinized (turns to transparent). Then the rest ingredients were added and well mixed following by cooking au bain marie at 100° C. for another 5 min. The mixture was cooled down to room temperature and then filled into a cup or a box (see FIGS. 1a and b).

The sauce was covered and stored at 0˜4° C. overnight to form a gel. The gelled sauce can be demolded or cut into required shape. The gelled sauce was placed on top of the pre-cooked pasta. The ready to eat pasta which is ready for preparing consumption was chilled (see FIGS. 11c and d).

The ready to eat pasta was heated in a microwave oven for around 2 min until the gelled sauce melted. The melted sauce was mixed with the pasta and was ready for consumption (see FIG. 11e).

The sauce can maintain a liquid state at room temperature for at least 2 h (see FIG. 11f).

### Example 6

### Comparison of Melt Behavior of High-Protein Gels with Different Gelling Agents

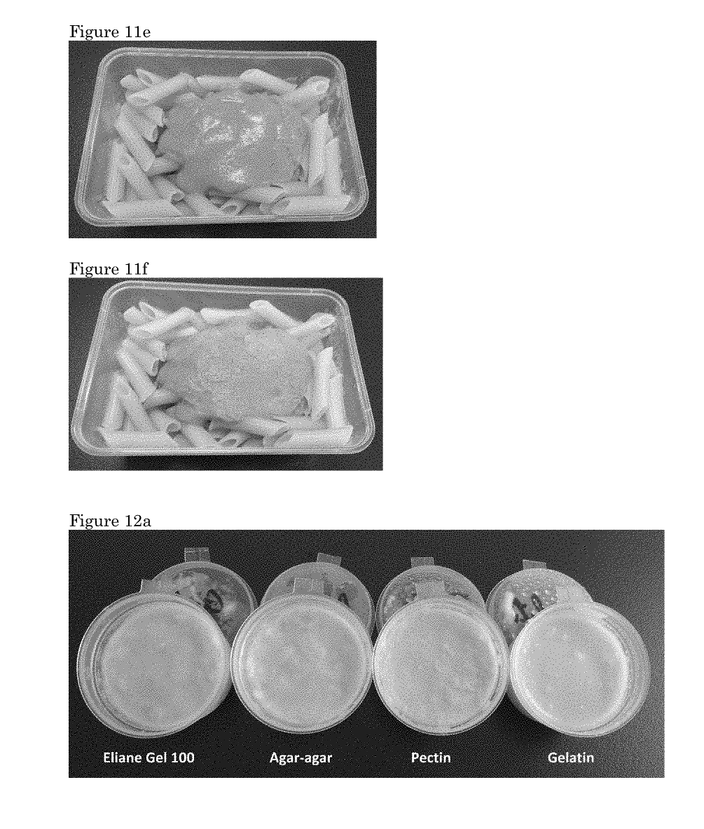

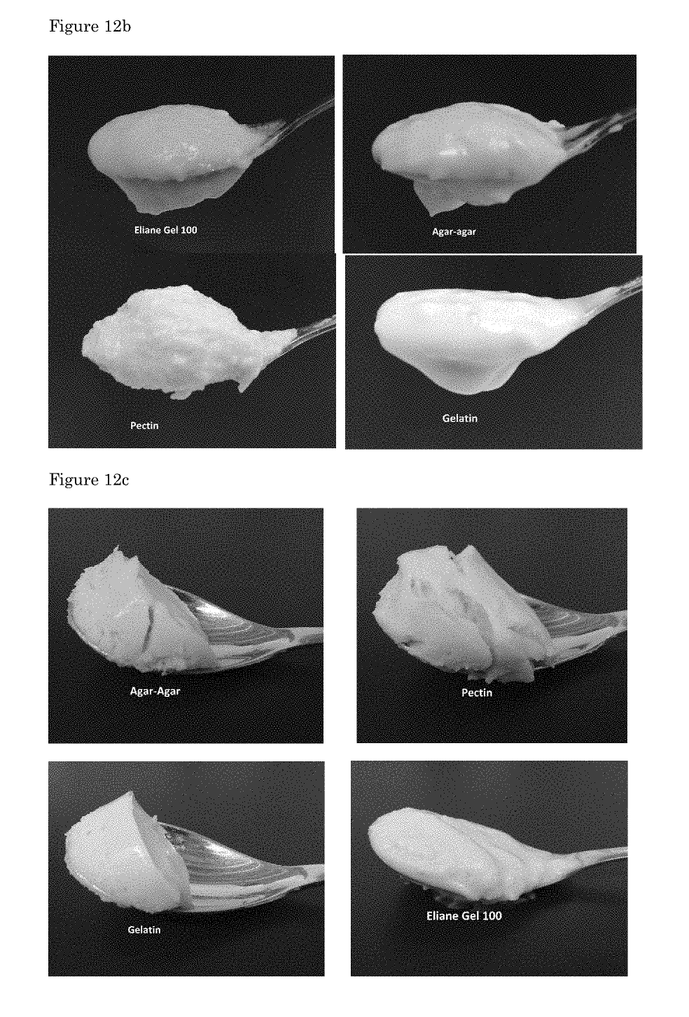

Gels were prepared as described in Example 1. The liquid mixtures were placed in transparent plastic cups, and allowed cool down to 7° C. in a fridge until the gelled state had been fully reached (FIG. 12a). Subsequently, the gels were heated in a water bath at 90° C. or in microwave (900 watts for 1 to 2 min) to obtain the melted gels in liquid form. Microwave or water bath heating functioned identically. A picture of the melted gel with the various gelling agents is shown in FIG. 12b.

The melted gel was kept at 25° C. Within minutes, the gels based on pectin, gelatin and agar agar returned to the gelled state. Pictures of the again fully gelled products based on pectin, gelatin and agar agar after 20 minutes are shown in FIG. 12c.

In contrast, the gel based on the starch thermoreversible gelling agent Eliane Gel 100 retained its liquid state for several hours at 25° C. A picture of the melted gel based on the starch thermoreversible gelling agent after 1 hour at 25° C. is also shown in FIG. 12c.

From these pictures, it can be seen that a food product based on a starch thermoreversible gelling agent can be consumed in liquid state long after cooling to room temperature, whereas food products based on non-starch based thermoreversible gelling agents can only be consumed in liquid state when still hot, and thus must be consumed swiftly after melting.

### Example 7

### Comparison with Prior Art Product

Experiment 1 of WO 03/015538 was repeated with and without the addition of modified waxy maize starch. It must be noted that the modified waxy maize starch in WO 03/015538, without any definition as to the type and extent of modification, cannot be considered a thermoreversible gelling starch. This can be seen in the following comparison.

Two butter garlics were prepared, following the recipes A and B in table 7.

TABLE 7
butter garlic composition with and without modified
waxy maize starch.

| | Recipe A | |
|---|---|---|
| | Original recipe of | Recipe B |
| | Example 1 of | Modified |
| | WO 03/015538 | recipe |
| Ingredient | (% w/w) | (% w/w) |
| Water | 35.0 | 35.0 |
| Partially hydrogenated | 25.0 | 25.0 |
| soybean oil | | |
| Butter | 15.0 | 20.0 |
| Gelatin | 5.0 | 5.0 |
| Milk protein concentrate | 5.0 | 5.0 |
| Modified waxy maize | 5.0 | / |
| starch | | |
| (acetylated waxy maize | | |
| starch) | | |
| Nonfat dry milk | 4.0 | 4.0 |
| Salt | 2.0 | 2.0 |
| Garlic powder | 1.5 | 1.5 |
| Disodium phosphate | 1.0 | 1.0 |
| Xanthan gum | 0.5 | 0.5 |
| Natural flavors (here use | 0.5 | 0.5 |
| garlic flavor) | | |
| Food coloring (here use β | 0.05 | 0.05 |
| carotene) | | |

The results are shown in table 8. The results show that modified waxy maize starch does not significantly alter the gelation behavior of the garlic butter. The thermoreversible gelling behavior is not due to the presence of modified waxy maize starch. In addition, the results show that the garlic butter of WO 03/015538 is not capable of retaining its liquid form for prolonged periods after cooling to room temperature. Thus, the garlic butter from WO 03/015538 does not comprise a thermoreversible gelling starch, and consequently, does not display the favorable long melt time associated with the protein-fortified food products of the present invention.

TABLE 8
gel behavior of the garlic butter of WO 03/015538 with
and without modified waxy maize starch.

| Test condition | Recipe A | Recipe B |
|---|---|---|
| State of the product | Good gel | Good gel |
| after cooling | | |
| overnight to 7° C. | | |
| State of the product | Liquefied, | Liquefied, |
| after heating a water | molten gel | molten gel |
| bath at 100° C. until | | |
| molten | | |
| State of the product | Same gel as before | Same gel as before |
| after cooling to 20° C. | heating | heating |
| for 15 minutes | | |

1. A protein-fortified food product (NutriDeliS), comprising water, a starch thermoreversible gelling agent and at least 2 wt. % of protein.

2. A NutriDeliS according to claim 1, comprising at least 12 wt. % of protein.

3. A NutriDeliS according to claim 1, wherein the NutriDeliS comprises 3-45 wt. % of the starch thermoreversible gelling agent.

4. A NutroDeliS according to claim 1, wherein the starch thermoreversible gelling agent is an acid-degraded amylopectin potato starch.

5. A NutriDeliS according to claim 1, wherein the protein is a fully or partially denatured or hydrolyzed protein, or a native protein, or any mixture thereof.

6. A NutriDeliS according to claim 1, further comprising one or more food-grade components selected from the group of fat, oil, carbohydrate, fiber, mineral, salt, sugar, acid, micronutrient, vitamin, antioxidant, flavonoid, colorant, flavoring compound, thickeners, and preservatives; and/or one or more of the food ingredients fruit, vegetable, meat, fish, dairy products; and further optionally comprising one or more pharmaceutical compounds.

7. A NutriDeliS according to claim 1, which is a solid gel, defined as a gel which without support or mold does not change shape under the force of gravity for at least one day.

8. A NutriDeliS according to claim 1, which is in melted form having a viscosity of 100-45000 cP.

9. A package, comprising at least one NutriDeliS according to claim 1, in the form of a single food portion.

10. A package according to claim 9, wherein the single food portion has a three-dimensional shape, preferably selected from a block, slice, disk, shred, ball or oval.

11. A method for serving protein-fortified food, comprising
1) providing a NutriDeliS according to claim 1;
2) heating the NutriDeliS to obtain a melted NutriDeliS, having a viscosity of 100-45000 cP;
3) serving the food.

12. A method according to claim 11, wherein the NutriDeliS is combined with another food product, preferably a servable portion of a meal or meal base selected from the group of pasta, noodles, rice, bread, potato dessert or ice cream.

13. A method for protein fortification in healthy subjects, comprising serving a protein-fortified food as defined in claim 1.

14. A NutriDeliS according to claim 1, for use in protein fortification in subjects suffering from protein deprivation.

15. A method of making a gelled food product, comprising mixing water, a starch thermoreversible gelling agent and at least 2 wt. % protein, heating the mixture to fully gelatinize the starch, and cooling the mixture for at least 5 hours, to obtain the gelled food product.
